(19) United States
(12) Patent Application Publication
(10) Pub. No.: US 2013/0075992 A1
(43) Pub. Date: Mar. 28, 2013

(54) STROLLER

(71) Applicant: Wanquan Zhu, Dongguan (CN)

(72) Inventor: Wanquan Zhu, Dongguan (CN)

(21) Appl. No.: 13/623,122

(22) Filed: Sep. 20, 2012

(30) Foreign Application Priority Data
Sep. 22, 2011 (CN) 201120358013.8

(51) Int. Cl. B62B 7/14

(52) U.S. Cl. 280/47.38

(57) ABSTRACT

The present invention discloses a stroller including a frame, at least one first engaging component, an infant seat, and at least one second engaging component. The frame includes a seat tube, and the seat tube includes an engaging stick. The at least one first engaging component is installed on the engaging stick. The infant seat detachably is installed on the seat tube. The least one second engaging component is installed on the infant cat seat for detachably engaging with the at least one first engaging component, so that the infant seat is detachably fixed on the frame.

### BACKGROUND OF THE INVENTION

1. Field of the Invention

The present invention relates to a stroller, and specifically relates to a stroller with easy assembly.

2. Description of the Prior Art

It is well known that there is no specialized car seat for infant and children, originally equipped inside the car. When parents take their baby to go outside by a car, sitting and security of the baby are big problems for the parents because the baby cannot sit on the car seat designed for adults, directly. For solving these problems, various manufacturers of children products manufacture an infant safety seat for an infant to sit and for being installed inside the car directly, so that the infant can sit on the infant safety seat comfortably and safely. In addition, for using the infant safety seat more conveniently, the infant seat can be disassembled from the car and installed on a frame of a stroller when the baby doesn't need to sit inside the car. Therefore the baby can sit on the infant safety seat on the stroller, and the parents can easily carry the baby by the stroller. Hence, it is more convenient for parents to take care of the baby.

The most common used stroller includes a seat and a frame. The seat can be the infant safety seat described above for the baby to sit, or it can be another kind of seat, such as a dinning chair or a swing chair. The frame includes a seat tube, and the seat can be supported on the seat tube, so that the seat can be installed on the frame. For convenient utilization, the seat can be installed on the frame in a detachable manner. However, it is difficult and wastes much time to install or disassemble the conventional seat of the stroller for users.

Therefore, it is needed to provide a stroller to overcome above problems, so that the seat can be easily installed on the frame or detached from the frame.

### SUMMARY OF THE INVENTION

The present invention is to provide a stroller with easy assembly to solve above problems. It is convenient and easy to install and detach an infant seat and a frame of the stroller, so that the stroller can be utilized more conveniently.

In order to achieve above purposes, the present invention is to provide a stroller including a frame, at least one first engaging component, an infant seat, and at least one second engaging component. The frame includes a seat tube, and the seat tube includes an engaging stick. The at least one first engaging component is installed on the engaging stick. The infant seat detachably is installed on the seat tube. The least one second engaging component is installed on the infant cat seat for detachably engaging with the at least one first engaging component, so that the infant seat is detachably fixed on the frame.

Preferably, the stroller includes two first engaging components, and each first engaging component is a hook.

Preferably, the at least one second engaging component is a ring.

Preferably, the frame further comprises a front handrail, and the stroller further comprises an engaging part installed under the infant seat for engaging with the front handrail of the frame, so that a front part of the infant car is supported on the front handrail.

Preferably, an end of the engaging part is bent and extended to form an engaging portion for engaging with the front handrail.

Preferably, the stroller further includes two engaging bases and two protrusions. The two engaging bases are installed on two sides of the seat tube respectively. The two protrusions corresponding to the two engaging bases are installed on two sides of the infant seat for respectively engaging inside the engaging base in an expansible manner.

Preferably, an engaging slot is formed inside each engaging base for containing the corresponding protrusion.

Preferably, a bottom surface of the protrusion obliquely extends to a top surface of the protrusion to form an inclined surface.

Preferably, the stroller further includes at least one supporting block installed on the engaging stick for supporting the frame to stand as the frame is folded.

Preferably, the stroller further includes a seat belt and a buckle for buckling the seat belt.

The stroller of the present invention includes an engaging stick installed on the seat tube, and the engaging stick includes at least one first engaging component. At least one second engaging component is installed on the infant seat for detachably engaging with the at least one first engaging component. Hence, the infant seat can be installed on the frame by the engagement of the first engaging component and the second engaging component cooperatively, or the infant seat can be detached from the frame by the disassembly of the first engaging component and the second engaging component cooperatively, so that it is easy to install the infant seat on the frame or detach the infant seat from the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a stroller according to an embodiment of the present invention.

FIG. 2 is a schematic drawing of a seat tube according to the embodiment of the present invention.

FIG. 3 is a partly enlarged drawing of part A illustrated in FIG. 1 according to the embodiment of the present invention.

FIG. 4 is a schematic drawing of a first engaging component illustrated in FIG. 2 according to the embodiment of the present invention.

FIG. 5 is a rear view of the stroller according to the embodiment of the present invention.

FIG. 6 is a partly enlarged drawing of part C illustrated in FIG. 5 according to the embodiment of the present invention.

FIG. 7 is a sectional view along with a line IV-IV illustrated in FIG. 6 according to the embodiment of the present invention.

FIG. 8 is another sectional view along with the line IV-IV illustrated in FIG. 6 in another situation according to the embodiment of the present invention.

FIG. 9 is a schematic drawing of the stroller at another viewing angle illustrated in FIG. 1 according to the embodiment of the present invention.

FIG. 10 is a partly enlarged drawing of part D illustrated in FIG. 9 according to the embodiment of the present invention.

FIG. 11 is a schematic drawing of a protrusion installed on the stroller illustrated in FIG. 1 according to the embodiment of the present invention.

FIG. 12 is a partly enlarged drawing of part B illustrated in FIG. 2 according to the embodiment of the present invention.

FIG. 13 is a schematic drawing of the stroller in a folded state illustrated in FIG. 1 according to the embodiment of the present invention.

### DETAILED DESCRIPTION

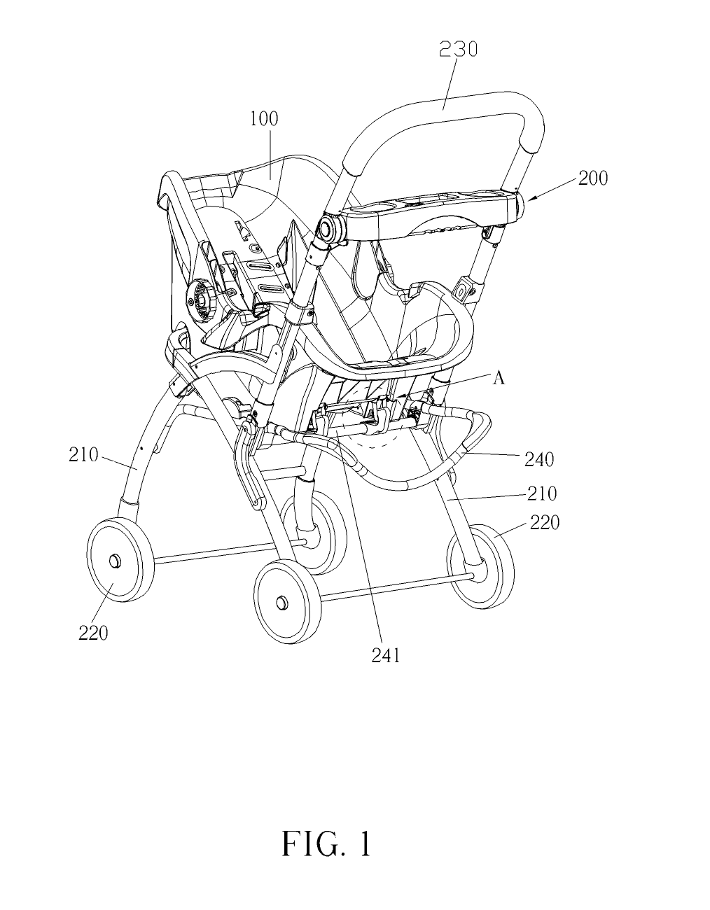

Please refer to figures for describing an embodiment of the present invention. Similar denotes of components represent the similar components in figures. Please refer to FIG. 1. FIG. 1 is a schematic drawing of a stroller according to an embodiment of the present invention. The stroller includes an infant seat 100 and a frame 200. The infant seat 100 can be a car safety seat, or it can be another kind of seat, such as a dinning chair or a swing chair, so as to expand the application range and ways of utilization. In addition, the stroller further includes a seat belt and a buckle for buckling the seat belt (not shown in figures), and the infant seat 100 can be fastened on other supporter, such as a car seat, a dinning seat, a common chair and so on, by the seat belt and the buckle. The infant seat 100 can be installed on the frame 200 for a baby to sit. The frame 200 includes a plurality of support feet 210, a plurality of wheels 220, a handle 230 and a seat tube 240. In this embodiment, the frame 200 includes four support feet 210 and four wheels 220. Each of the wheels 220 is pivotally connected to a low end of the corresponding support foot 210 to support the stroller to move. The handle 230 and the seat tube 240 are pivotally connected to the support feet 210, so that the frame 200 can be folded for easily carrying. The handle 230 is disposed at a rear part of the frame 200 and extends upward, so as to facilitate caregivers to hold and drive the stroller. The seat tube 240 is installed between the support feet 210 for supporting the infant seat 100.

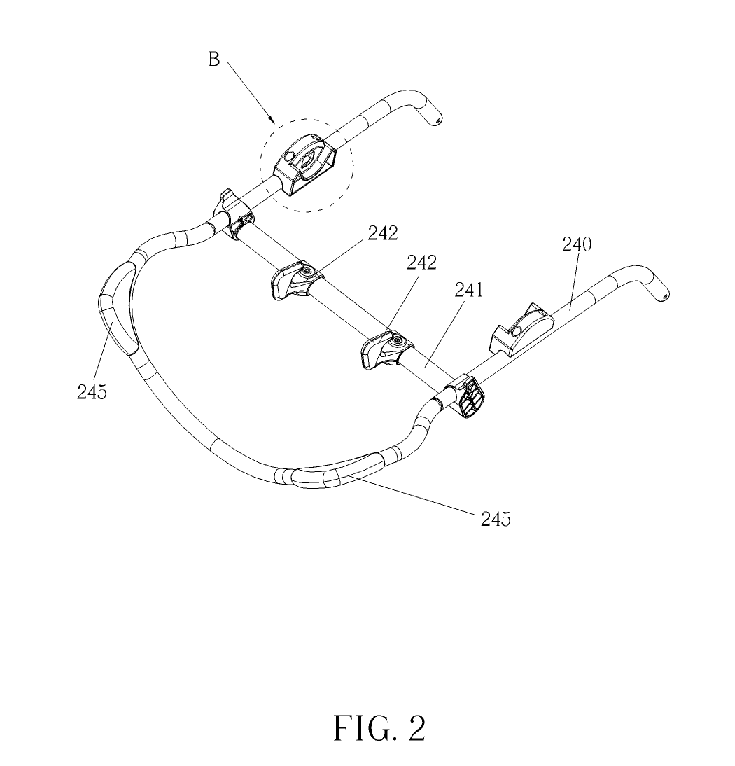

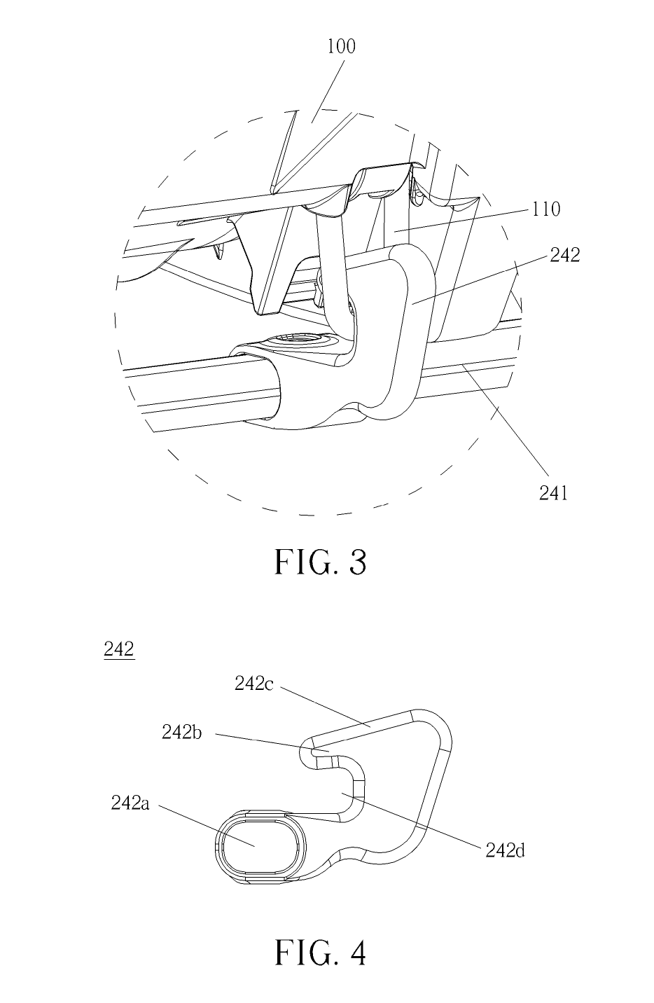

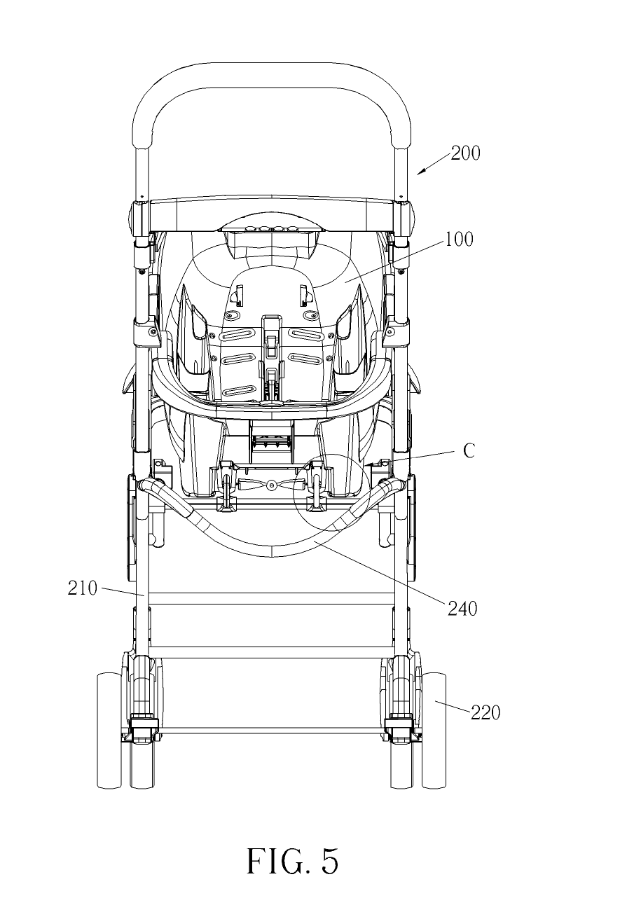

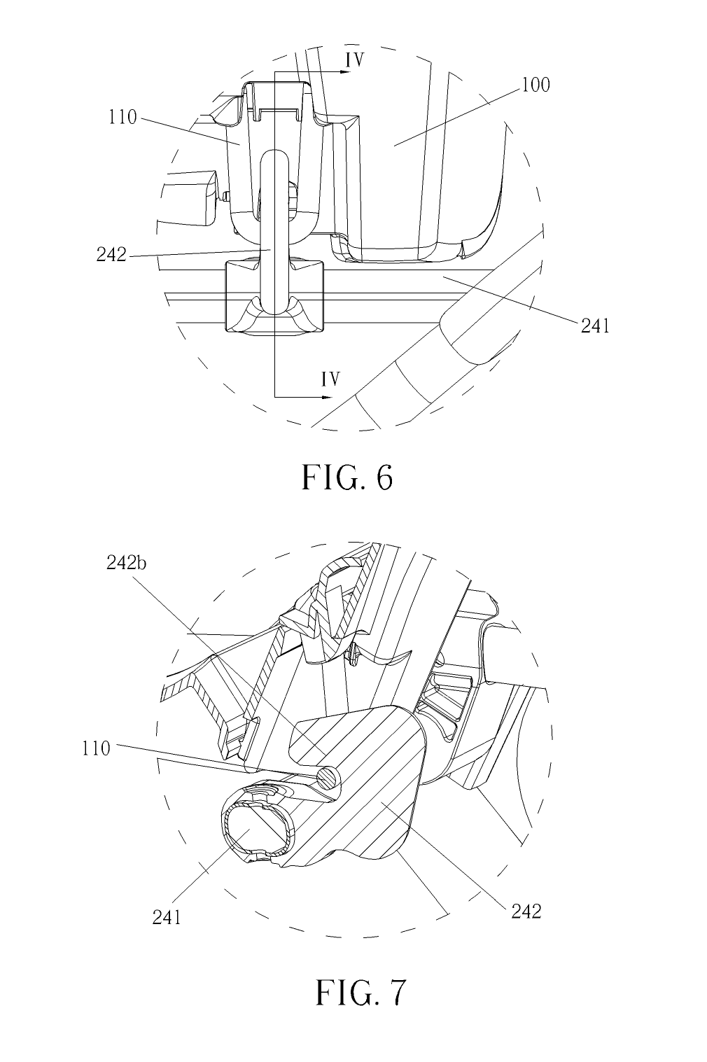

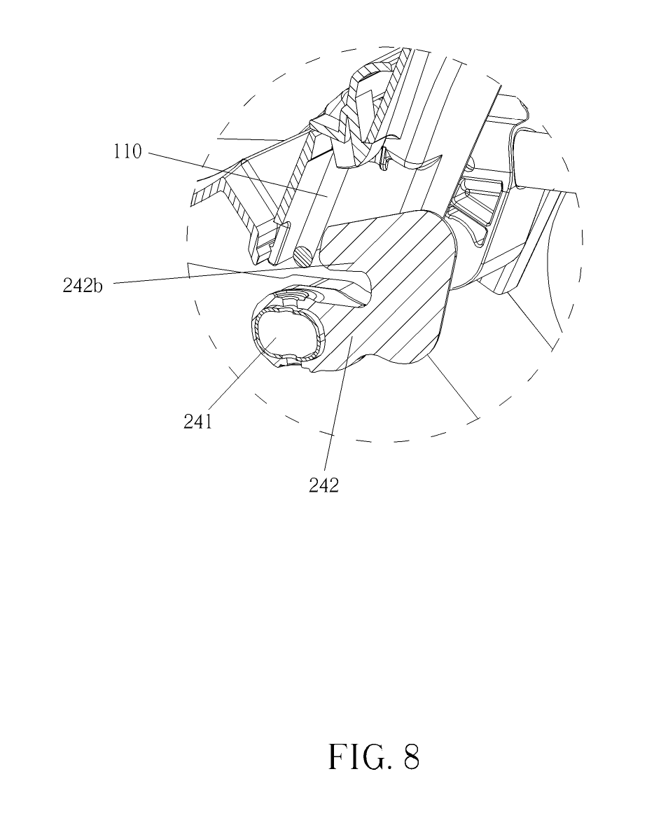

Please refer to FIG. 2. FIG. 2 is a schematic drawing of the seat tube 240 according to the embodiment of the present invention. The seat tube 240 includes an engaging stick 241 for engaging with the infant seat 100 when the infant seat 100 is installed on the frame 200. Please refer to FIG. 2 to FIG. 8. FIG. 3 is a partly enlarged drawing of part A illustrated in FIG. 1 according to the embodiment of the present invention. FIG. 4 is a schematic drawing of a first engaging component 242 illustrated in FIG. 2 according to the embodiment of the present invention. FIG. 5 is a rear view of the stroller according to the embodiment of the present invention. FIG. 6 is a partly enlarged drawing of part C illustrated in FIG. 5 according to the embodiment of the present invention. FIG. 7 is a sectional view along with a line IV-IV illustrated in FIG. 6 according to the embodiment of the present invention. FIG. 8 is another sectional view along with the line IV-IV illustrated in FIG. 6 in another situation according to the embodiment of the present invention. As shown in FIG. 2, the engaging stick 241 is installed on the seat tube 240 horizontally, and at least one first engaging component 242 is installed on the engaging stick 241. As shown in FIG. 3, at least one second engaging component 110 corresponding to the at least one first engaging component 242 is installed on a rear end of the infant seat 100 for detachably engaging with the at least one first engaging component 242, so that the infant seat 100 is detachably fixed on the frame 200 and is supported by the seat tube 240.

In this embodiment, the stroller includes two first engaging components 242, and each first engaging component 242 is a hook. A hole 242a is disposed on the first engaging components 242 for sheathing the engaging stick 241. A size of the hole 242a can be the same with a size of the engaging stick 241, so that the first engaging components 242 can be fixed on the engaging stick 241 tightly. In this embodiment, the hole 242a can be an ellipse-shaped hole so as to prevent the first engaging components 242 from rotating relative to the engaging stick 241. As shown in FIG. 4, the first engaging components 242 is extended far from the hole 242a to form a hook portion 242b. An incline 242c is formed on an upper end of the hook portion 242b, and a notch 242d is formed on a lower end of the hook portion 242b. As shown in FIG. 3, the stroller includes two second engaging components 110 corresponding to the two first engaging components 242, and each second engaging component 110 is a ring. An end of the second engaging component 110 is connected to a bottom of the infant seat 100, and the second engaging component 110 is driven by a operational component on the infant seat 100 (no shown in figures) to rotate. When the infant seat 100 is supported on the seat tube 240, the operational component can be operated to drive the second engaging components 110 to engage with the first engaging components 242, so that the infant seat 100 is fixed on the seat tube 240. As shown in FIG. 7, the second engaging component 110 is engaged with the first engaging components 242.

Moreover, the infant seat 100 can be pushed downward to drive the second engaging component 110 to contact against the incline 242c of the hook portion 242b of the first engaging component 242, so that the second engaging component 110 can slide along with the incline 242c. And then the incline 242c can force the second engaging component 110 to rotate. After that, when the infant seat 100 continues to be pushed downward and installed on the frame 200, the second engaging component 110 will be forced by a restoring force of a resilient component (not shown in figures) to move close to the notch 242d until the second engaging component 110 is engaged with the hook portion 242b. When users need to detach the infant seat 100 from the frame 200, users can operate the operational component of infant seat 100 to drive the second engaging component 110 to rotate, so that the first engaging component 242 is detached from the second engaging component 110. That is, as shown in FIG. 8, the ring is detached from the hook portion 242b. Therefore the first engaging component 242 and the second engaging component 110 are in a detaching state, and then users can detach the infant seat 100 from the frame 200.

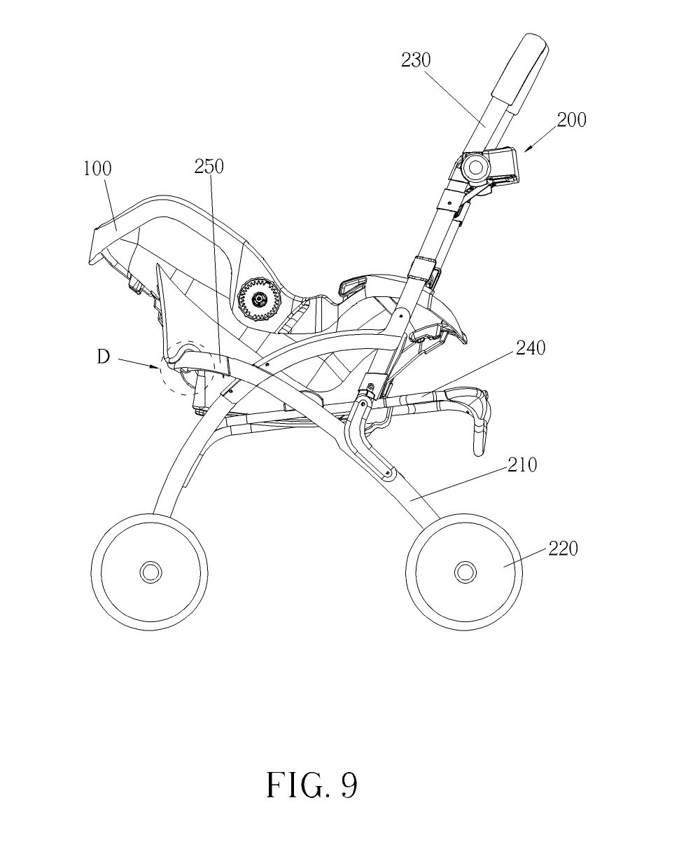

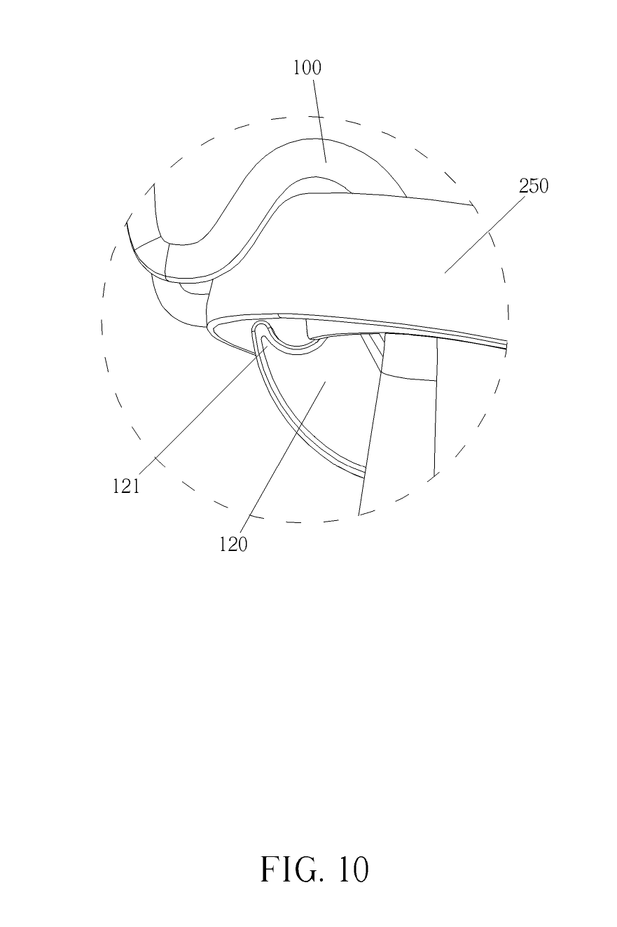

Please refer to FIG. 9 and FIG. 10. FIG. 9 is a schematic drawing of the stroller at another viewing angle illustrated in FIG. 1 according to the embodiment of the present invention. FIG. 10 is a partly enlarged drawing of part D illustrated in FIG. 9 according to the embodiment of the present invention. As shown in FIG. 9, the frame 200 further includes a front handrail 250 installed on the support frames 210 and disposed at a front end of the frame 200, so as to support the infant seat 100 on the frame 200 stably. As shown in FIG. 10, an engaging part 120 is installed under an end near the front handrail 250 of the infant seat 100. A free end of the engaging part 120 is bent and extended to form an engaging portion 121. The engaging portion 121 is engaged with a lower surface of the front handrail 250, so that a front end and a rear end of the infant seat 100 can be installed on the frame 200 stably by the engaging part 120 cooperated with the ring. In addition, the engaging portion 121 is engaged with the lower surface of the front handrail 250, and it can prevent the engaging portion 121 from hurting the baby sitting on the stroller.

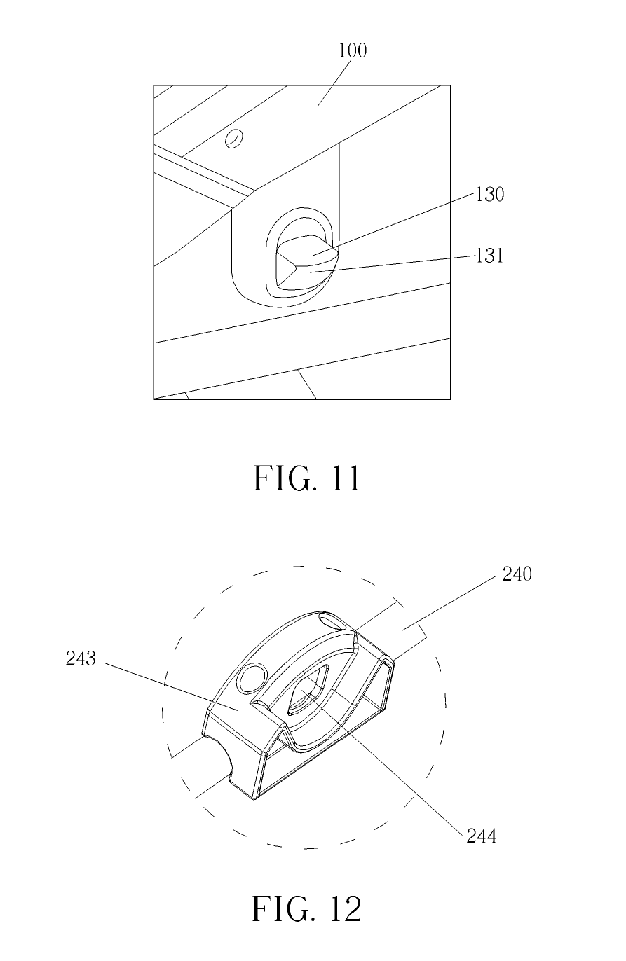

Please refer to FIG. 11 and FIG. 12. FIG. 11 is a schematic drawing of a protrusion 130 installed on the stroller illustrated in FIG. 1 according to the embodiment of the present invention. FIG. 12 is a partly enlarged drawing of part B illustrated in FIG. 2 according to the embodiment of the present invention. Two engaging bases 243 are installed on two inner sides of the seat tube 240 respectively. As shown in FIG. 12, an engaging slot 244 is formed inside each engaging base 243. In addition, two protrusions 130 corresponding to the two engaging bases 243 are disposed at two sides of the infant seat 100 for respectively engaging inside the engaging bases 243 in an expansible manner, so that the infant seat 100 can be fixed between the two engaging bases 243, so as to prevent the infant seat 100 from moving in a horizontal direction.

A bottom surface of the protrusion 130 obliquely extends to a top surface of the protrusion 130 to form an inclined surface 131. The inclined surface 131 can guide the protrusion 130 to engage inside the engaging slot 244 smoothly. In this embodiment, the protrusion 130 is further connected to a button and a resilient component (not shown in figures). When the button is pushed, the protrusion 130 will be driven to draw back inside a lateral wall of the infant seat 100, so that the protrusion 130 can be detached from the engaging slot 244. Therefore the infant seat 100 and the frame 200 can be released from the constraint of the horizontal direction. Besides, when the protrusion 130 is drawn back, the protrusion 130 will compress the resilient component. After the button is released, a resilient restoring force of the resilient component will push the protrusion 130 to extend outside the infant seat 100, and the protrusion 130 will be engaged inside the engaging slot 244 by the inclined surface 131 contacting against the engaging bases 243, so as to fix the infant seat 100 again. In summary, it is easy to install the infant seat 100 on the frame 200 and detach the infant seat 100 from the frame 200.

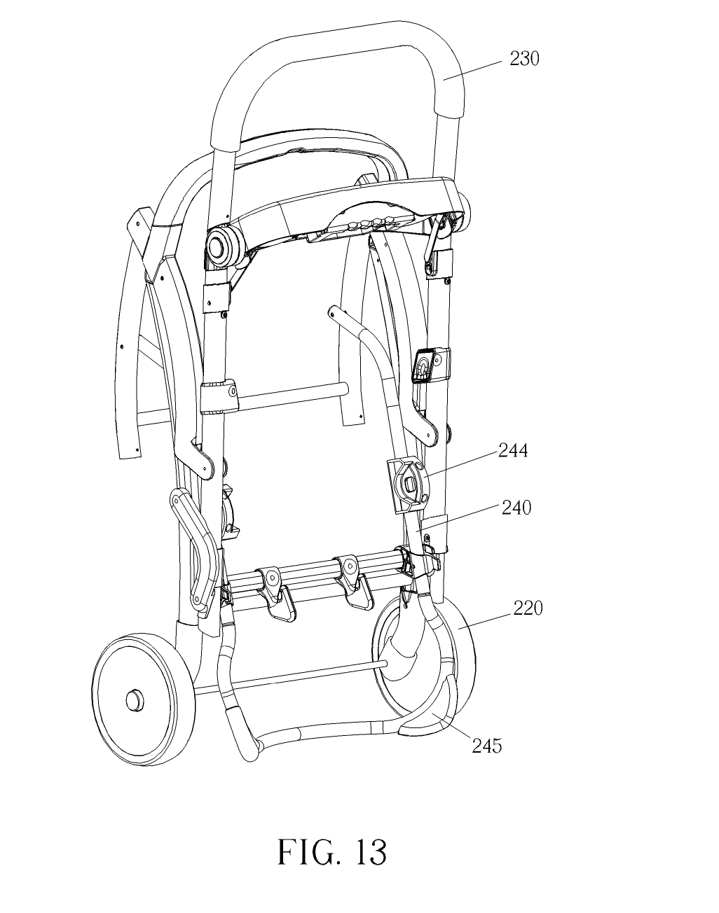

Please refer to FIG. 13 and previous figures cooperatively. FIG. 13 is a schematic drawing of the stroller in a folded state according to the embodiment of the present invention. In this embodiment, the stroller further includes at least one supporting block 245 installed on the engaging stick 241 of the seat tube 240. As shown in FIG. 13, after the frame 200 is folded, the supporting block 245 can support the frame 200 to stand on the ground stably.

In this embodiment, either of operating the first engaging components 242 to engage with the second engaging components 110 or operating the protrusions 130 to engage with the engaging bases 243 can fix the infant seat 100 on the frame 200. The stroller can be designed with above two mechanisms simultaneously or with only an alternative mechanism. In addition, the second engaging component 110 and the protrusion 130 can be disposed at different positions of the frame 200, and the first engaging component 242 and the engaging base 243 can be disposed at different positions of the seat, so that the frame 200 is suitable for different seats with different configuration. Therefore, it can expand the range of applications.

In conclusion, the stroller for the present invention is to install the infant seat 100 on the frame 200 stably by the engagement of the ring engaging and the hook, the engagement of the protrusion 130 and the engaging base 243 of the frame 200, and the engagement of the engaging part 120 and the front handrail 250 cooperatively. The procedure of installation is easy to perform. When users want to detach the infant seat 100 from the frame 200, users only have to press the button to draw the protrusion 130 back into the lateral wall of the infant seat 100, or operate the operational component to drive the second engaging component 110 to detach from the first engaging component 242, and then detach the engaging part 120 from the front handrail 250, so as to detach the infant seat 100 from the frame 200. As a result, users can install the infant seat 100 on the frame 200 or detach the infant seat 100 from the frame 200 without any other assistant tool, so as to facilitate users to install the infant seat 100 on the stroller or to detach the infant seat 100 from the stroller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stroller, comprising:
a frame comprising a seat tube, and the seat tube comprising an engaging stick;
at least one first engaging component installed on the engaging stick;
an infant seat detachably installed on the seat tube; and
at least one second engaging component installed on the infant seat for detachably engaging with the at least one first engaging component, so that the infant seat is detachably fixed on the frame.

2. The stroller of claim 1, wherein the stroller comprises two first engaging components, and each first engaging component is a hook.

3. The stroller of claim 2, wherein the at least one second engaging component is a ring.

4. The stroller of claim 2, wherein the frame further comprises a front handrail, and the stroller further comprises an engaging part installed under the infant seat for engaging with the front handrail of the frame, so that a front part of the infant car is supported on the front handrail.

5. The stroller of claim 4, wherein an end of the engaging part is bent and extended to form an engaging portion for engaging with the front handrail.

6. The stroller of claim 1, further comprising:
two engaging bases installed on two sides of the seat tube respectively; and
two protrusions corresponding to the two engaging bases installed on two sides of the infant seat for respectively engaging inside the engaging base in an expansible manner.

7. The stroller of claim 6, wherein an engaging slot is formed inside each engaging base for containing the corresponding protrusion.

8. The stroller of claim 7, wherein a bottom surface of the protrusion obliquely extends to a top surface of the protrusion to form an inclined surface.

9. The stroller of claim 6, wherein the frame further comprises a front handrail, and the stroller further comprises an engaging part installed under the infant seat for engaging with the front handrail of the frame, so that a front part of the infant car is supported on the front handrail.

10. The stroller of claim 9, wherein an end of the engaging part is bent and extended to form an engaging portion for engaging with the front handrail.

11. The stroller of claim 1, further comprising at least one supporting block installed on the engaging stick for supporting the frame to stand as the frame is folded.

12. The stroller of claim 1, further comprising a seat belt and a buckle for buckling the seat belt.
